(19) United States
(12) Patent Application Publication
(10) Pub. No.: US 2009/0172621 A1
(43) Pub. Date: Jul. 2, 2009

(54) SYSTEM AND METHOD FOR SYSTEM-ON-CHIP (SOC) PERFORMANCE ANALYSIS

(75) Inventors: Sandeep Jayant Sathe, Pune (IN); Prachi Sandeep Sathe, Pune (IN)

Correspondence Address: Rahman LLC, 10025 Governor Warfield Parkway, Suite 110, Columbia, MD, 21044, US

(73) Assignee: Sanved Dessiggn Automation, Bangalore (IN)

(21) Appl. No.: 12/344,879

(22) Filed: Dec. 29, 2008

(30) Foreign Application Priority Data
Dec. 27, 2007 (IN) 3113/CHE/2007

(51) Int. Cl. G06F 17/50

(52) U.S. Cl. 716/6

(57) ABSTRACT

A system and method of performing transaction level System on Chip (SoC) performance analysis includes obtaining a SoC description file including all intellectual property (IP) modules interconnected in a SoC via interconnects, calculating clock periods of the IP modules, calculating a greatest common divisor (GCD) of all the clock periods, receiving user-specified inputs that stimulate the SoC and generate a signal at an output of the SoC, gathering timing and interconnect statistics from the SoC, automatically generating a top level module based on the statistics, compiling the top level module and the components to generate an executable file, simulating a SoC system by running the executable file, and generating performance results from the simulated SoC system.

### CROSS-REFERENCE TO RELATED APPLICATIONS

This application claims the benefit of Indian provisional patent application no. 3113/CHE/2007, filed on Dec. 27, 2007, the complete disclosure of which, in its entirety, is herein incorporated by reference.

### BACKGROUND

1. Technical Field

The embodiments herein generally relate to semiconductor integrated circuits, and, more particularly, to System on Chip (SoC) performance analysis.

2. Description of the Related Art

In the mid-1990s, Application Specific Integrated Circuit (ASIC) technology evolved from a chip-set philosophy to an embedded-cores-based system-on-a-chip (“SoC”) concept. A SoC is an IC designed by stitching together multiple stand-alone VLSI designs to provide full functionality for an application. It is composed of pre-designed models of complex functions known as cores (virtual components, and macros are also used) that serve a variety of applications. A SoC allows the designers to put a maximum amount of technology with highest performance in the smallest amount of space. While there is no question about its benefits, SoC design still comes with its own set of challenges, key ones being time-to-market and increasing complexity.

Semiconductor chip development started in the early 1970s at the small scale integration (SSI) level. Advancements in the semiconductor fabrication industry over the past few decades have resulted in CMOS transistors sizes becoming smaller and smaller. As geometries of CMOS transistors shrink, integrating a greater number of transistors on a single semiconductor die becomes feasible. Presently, 65 nm technology is prevalent in the industry, while 45 nm and smaller technologies are expected to be used in the near future. At these geometries, it is possible to accommodate multiple application specific integrated circuits and interconnects on one semiconductor die and, hence, an entire system can reside on a chip (SoC). Hence, at these lower geometries, complexities of SoCs continue to grow.

As SoC development has become prevalent, various on-chip bus protocols have been developed in order to standardize the interfaces between various blocks. AMBA AHB/AXI bus protocol available from ARM Limited of Cambridge England, or PLB bus protocol used by PowerPC are some of the popular on-chip busses. These on-chip busses are used to interconnect various modules in the SoC.

Intellectual property (IP) vendors typically provide fully verified and fully synthesizable IP modules which can be directly plugged into the SoC. This allows a shorter time to market for the SoC vendors. Some of the most commonly used reusable IP modules are single port and multiport memory controllers, single and multiport direct memory access (DMA) controllers, SATA controllers, peripherals like USB, PCI, and PCIe cores.

Also, IP vendors typically design their IP modules with configurable features and parameters in order to meet functional requirements of diverse SoC customer base. For example, in a multiport memory/DMA controller design, the number of ports is a very important parameter. Ethernet MACs support 10/100/1000 Mbps speeds to support various LAN speeds. Packet based designs support framing and streaming modes. Reusing an off-the-shelf IP block from an IP vendor, the SoC designer selects appropriate values for these configurable parameters in order to match the requirements of the particular SoC.

A typical SoC, at a block diagram level comprises of multiple IP blocks and on-chip buses to interconnect these IP blocks. The IP blocks can be developed in-house or can be off the shelf IP blocks from IP vendors. Most of IP's are fully verified at the unit level testing. Hardware design, simulation based functional verification, synthesis, static timing analysis, formal verification methodologies have matured to a great extent. A key challenge facing the SoC architect is the evaluation whether the SoC architecture can meet performance requirements.

To elaborate this point further, for instance consider a multiported DDR SDRAM controller (one of the most common IP blocks in the SoC). Most of the IP modules in a SoC are clients of the memory controller and typically one client connects to one port of the controller. At the port interface, command, read and write FIFO sizes are the configurable parameters of the memory controller. An arbitration scheme among various ports is another very important parameter which affects overall SoC performance. During SoC architecture development, the architect needs to configure FIFO depths, burst length, CAS latency, and memory data width parameters in order to achieve a maximum performance from the memory controller.

On-chip buses are designed to provide appropriate bandwidth at the interface. Various parameters which affect the available bandwidth are width of the data bus, operating clock frequency, size of burst, latency of one operation, and the number of simultaneous operations supported. Thus, the SoC architect should choose all these parameters optimally during SoC architecture stage.

During the architecture stage, SoC architects develop abstract models of their IPs. Stimulus models are also developed to exercise these IP models. A great amount of effort is required to modify and maintain the models as the number of configurable parameters increase. This results in many issues such that SoC architects end up with an incomplete analysis, which leads to changes during the later stages of the development or the SoC is functionally correct but underperforming. Sometimes, a phased approach is taken where a first release is meant only for achieving the correct functionality. Then, the performance testing is carried out on the functionally correct first release and any required design changes are incorporated in a second release to improve the performance.

As the semiconductor geometries shrink, the cost of a mask is increasing enormously. Furthermore, for each respin of a SoC, the SoC has to undergo a complete cycle of functional verification, regressions, synthesis, STA, DFT and layout. The resulting impact on Time-To-Market is huge.

### SUMMARY

The embodiments herein solve the problem of analyzing SoC performance evaluation and architecture exploration at the architecture stage by providing a software tool for this operation.

In view of the foregoing, an embodiment herein provides a method of performing transaction level System on Chip (SoC) performance analysis. The method includes obtaining a SoC description file comprising all intellectual property (IP) modules interconnected in a SoC via interconnects, calculating clock periods of the IP modules, calculating a greatest common divisor (GCD) of all the clock periods, receiving user-specified inputs that stimulate the SoC and generate a signal at an output of the SoC, gathering timing and interconnect statistics from the SoC, automatically generating a top level module based on the statistics, compiling the top level module and the components to generate an executable file, simulating a SoC system by running the executable file, and generating performance results from the simulated SoC system.

The method further includes gathering the statistics from a hardware library database. The hardware library database includes a direct memory access (DMA) controller module, a bus interface module, and a transmitter module. The modules include user-configurable parameters. The performance results include an evaluation of whether the DMA controller module, the bus interface module, and the transmitter module connected together meet a required wire speed of a predetermined corresponding transmission medium.

Additionally, the method includes identifying a reference time period as a base timing unit for performing the simulation of the SoC system. The GCD corresponds to said reference time period. The SoC description file includes any of a text format and a graphical format that is convertible into the text format. The IP modules include user-configurable parameters and key interconnects that facilitate data transfer from one IP module to another IP module in the SoC. The performance results include bus bandwidth utilization, data rates achieved at various media interfaces in the SoC, FIFO depth utilization, and a request to grant latency of an arbiter associated with the SoC.

The performance results are generated without register-transfer level (RTL) computer code. The method further includes identifying register-transfer level (RTL) signals to interact with the hardware library database, automatically generating programmable language interface (PLI) routine code from the RTL signals, and simulating the RTL signals and the PLI routine code. The performance results include the simulated RTL signals and PLI routine code.

Another embodiment herein provides a program storage device readable by computer and including a program of instructions executable by the computer to perform a method of performing transaction level System on Chip (SoC) performance analysis. The method includes obtaining a SoC description file comprising all intellectual property (IP) modules interconnected in a SoC via interconnects, calculating clock periods of the IP modules, calculating a greatest common divisor (GCD) of all the clock periods, receiving user-specified inputs that stimulate the SoC and generate a signal at an output of the SoC, gathering timing and interconnect statistics from the SoC, automatically generating a top level module based on the statistics, compiling the top level module and the components to generate an executable file, simulating a SoC system by running the executable file, and generating performance results from the simulated SoC system.

The method further includes gathering the statistics from a hardware library database. The hardware library database includes a direct memory access (DMA) controller module, a bus interface module, and a transmitter module. The modules include user-configurable parameters. The performance results include an evaluation of whether the DMA controller module, the bus interface module, and the transmitter module connected together meet a required wire speed of a predetermined corresponding transmission medium.

Additionally, the method includes identifying a reference time period as a base timing unit for performing the simulation of the SoC system. The GCD corresponds to the reference time period. The SoC description file includes any of a text format and a graphical format that is convertible into the text format. The IP modules include user-configurable parameters and key interconnects that facilitate data transfer from one IP module to another IP module in the SoC.

The performance results include bus bandwidth utilization, data rates achieved at various media interfaces in the SoC, FIFO depth utilization, and a request to grant latency of an arbiter associated with the SoC. The performance results are generated without register-transfer level (RTL) computer code. The method further includes identifying register-transfer level (RTL) signals to interact with the hardware library database, automatically generating programmable language interface (PLI) routine code from the RTL signals, and simulating the RTL signals and the PLI routine code. The performance results include the simulated RTL signals and PLI routine code.

Yet another embodiment herein provides a system for performing transaction level System on Chip (SoC) performance analysis. The system includes a SoC description file comprising all intellectual property (IP) modules interconnected in a SoC via interconnects, a processor that calculates clock periods of the IP modules, and calculates a greatest common divisor (GCD) of all the clock periods. The system further includes a graphical user interface (GUI) that receives user-specified inputs that stimulate the SoC and generate a signal at an output of the SoC, a hardware library database including timing and interconnect statistics from the SoC, a tool that automatically generates a top level module based on the statistics, a compiler that compiles the top level module and the components to generate an executable file, and a simulator that simulates a SoC system by running the executable file, and generates performance results from the simulated SoC system.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a block diagram of the tool to perform architecture exploration and performance evaluation of SoC at the architecture stage according to an embodiment herein;

FIG. 2 illustrates an exploded view of the performance analysis block of FIG. 1 according to an embodiment herein;

FIG. 3 is a flow diagram illustrating a method of determining a performance result of the SoC of FIG. 1 according to an embodiment herein;

FIGS. 4A-4B are table views of the hardware library component database of FIG. 1 according to an embodiment herein;

FIG. 5 is a graphical illustration of how a SoC will be described and interconnected in the GUI according to an embodiment herein;

FIG. 6 illustrates a resource utilization histogram according to an embodiment herein;

FIG. 7 illustrates a shared resource utilization according to an embodiment herein;

FIG. 8 illustrates a time chart of important events during simulation according to an embodiment herein 1;

FIG. 9 is a block diagram of performance evaluation at the RTL stage according to an embodiment herein;

FIG. 10 is a flowchart of the performance evaluation at the RTL stage according to an embodiment herein;

FIG. 11 is an example SoC according to an embodiment herein; and

FIG. 12 illustrates a schematic diagram of a computer architecture used in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

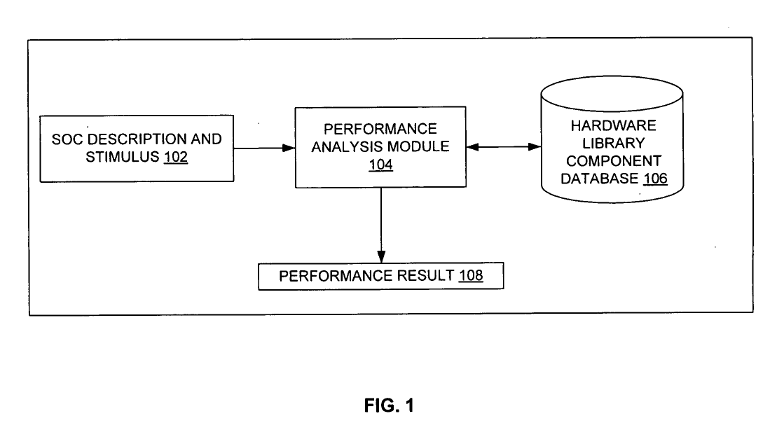

The embodiments herein provide a SoC with correct functionality. Referring now to the drawings, and more particularly to FIGS. 1 through 12, where similar reference characters denote corresponding features consistently throughout the figures, there are shown preferred embodiments.

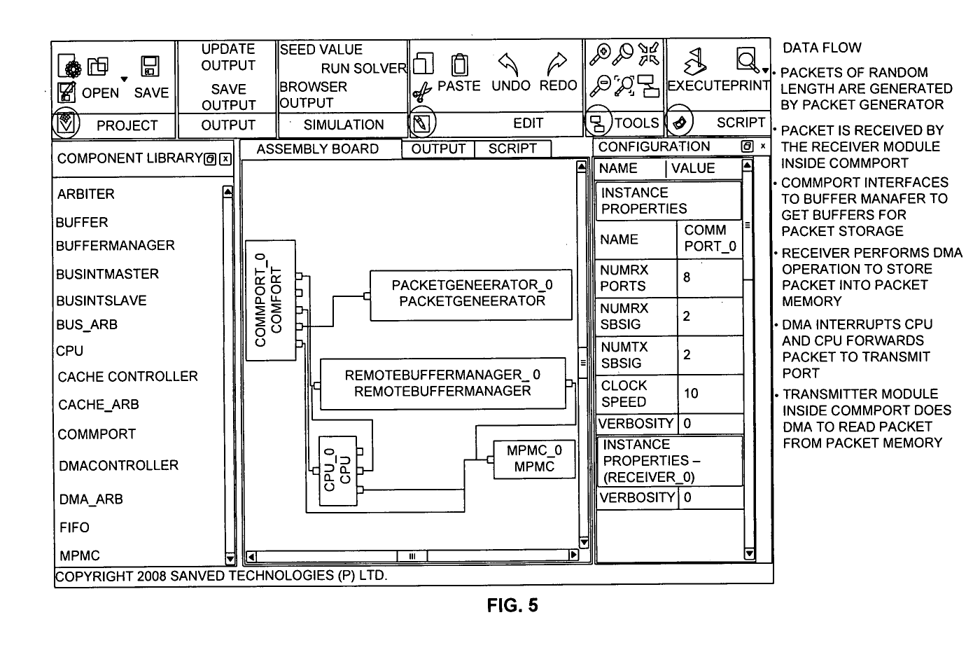

FIG. 1 illustrates a block diagram of a system for architecture exploration and performance analysis of a SoC having a SoC description and stimulus block 102, a performance analysis block 104, a hardware library component database 106, and a performance result block 108 according to an embodiment herein. The SoC description and stimulus block 102 allows the SoC architect to describe the SoC and stimulus to the SoC in the text file in a predefine syntax. All of the primary inputs of the SoC will be driven by the stimulus during the simulation. For example, as described in FIG. 5, CommPort (Communication Port) component receives packetized data over a serial interface. A Packet Generator component acts as the stimulus for CommPort. The Packet Generator generates a packet of random length, serializes the data, and transmits it serially which is received by the CommPort.

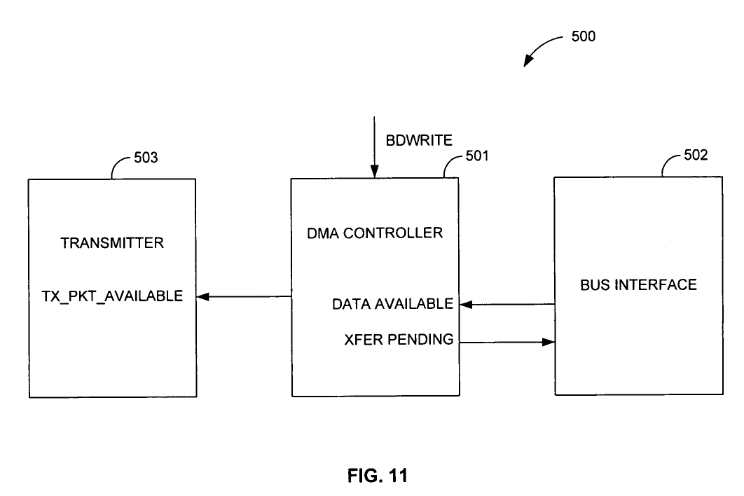

The SoC architect may provide the SoC description in a graphical format, as is illustrated in FIG. 5, and the tool automatically converts the graphical information into a text format. The description provided in the text file includes all IP modules contained within the SoC and key interconnects among various IP modules. The description of an IP includes configurable parameters and key interconnects which facilitates data transfer from one IP module to other IP modules in the SoC. The SoC architect may also provide timing guidelines which reflect the number of clock cycles consumed by an actual hardware component. Timing guidelines are configurable parameters for the library components in the database 106 of FIG. 1 which allows the user to mimic actual hardware latencies. For example, consider the DMA Controller model 500 as shown in FIG. 11, which mimics the functionality of the DMA Controller hardware component 501. The library database component 106 executes its entire functionality in zero simulation time while real hardware would take finite number of clocks to perform this functionality. The timing guideline parameter of the DMA Controller model 500 allows the model to mimic the latency incurred by actual hardware DMA Controller 501. The timing guideline parameter set at the architecture stage can be inaccurate. After RTL development, this parameter will be known more accurately. The SoC Architect can change this parameter and evaluate the performance again. Thus, performance analysis at the architecture stage followed by at the RTL stage will provide much greater confidence to the SoC Architect that the selected architecture meets the required performance.

The performance analysis block 104 of FIG. 1 provides an automation to generate the top level module (main program to instantiate all the components of the given SoC description file) and simulates and provides performance analysis results automatically.

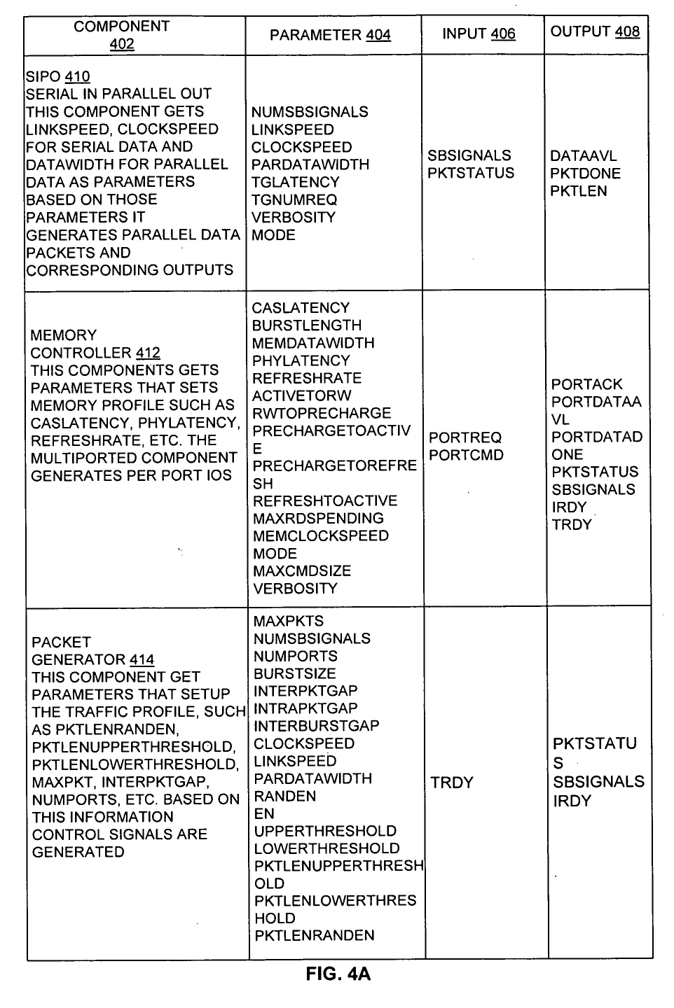

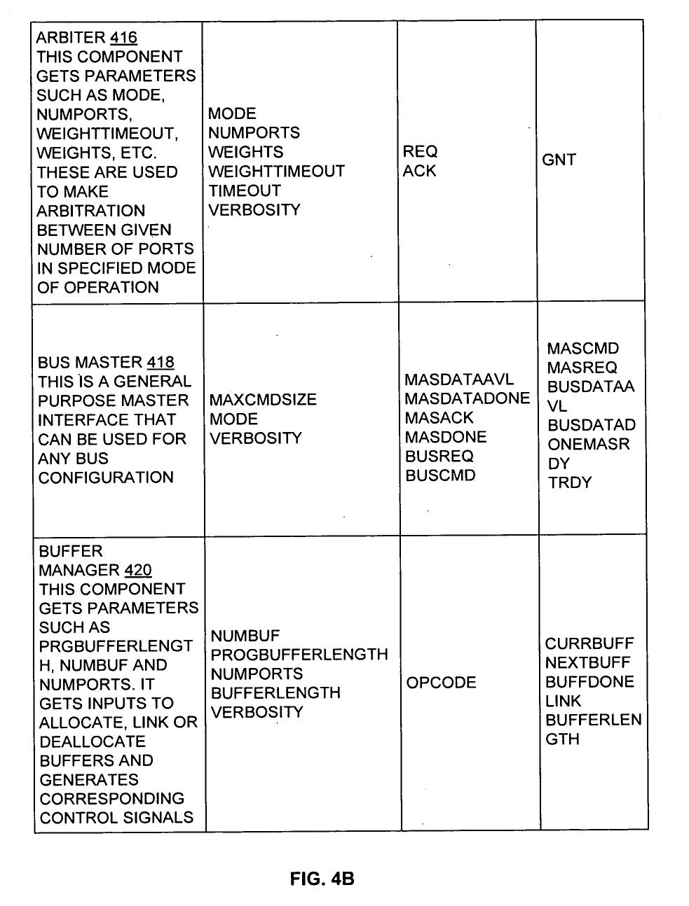

The hardware library component block 106 of FIG. 1 includes library components along with configurable parameters and interconnected signals. In one embodiment, the hardware library components include Serial in Parallel out (SIPO), memory controller, packet generator, arbiter, bus master, and buffer manager along with their parameters and interconnects as described in FIG. 4A and FIG. 4B. The performance result block 108 of FIG. 1 provides a performance analysis of the hardware library components within the SoC. In one embodiment, the performance result block includes analysis results of data rates, bus bandwidths, FIFO depth utilization, etc.

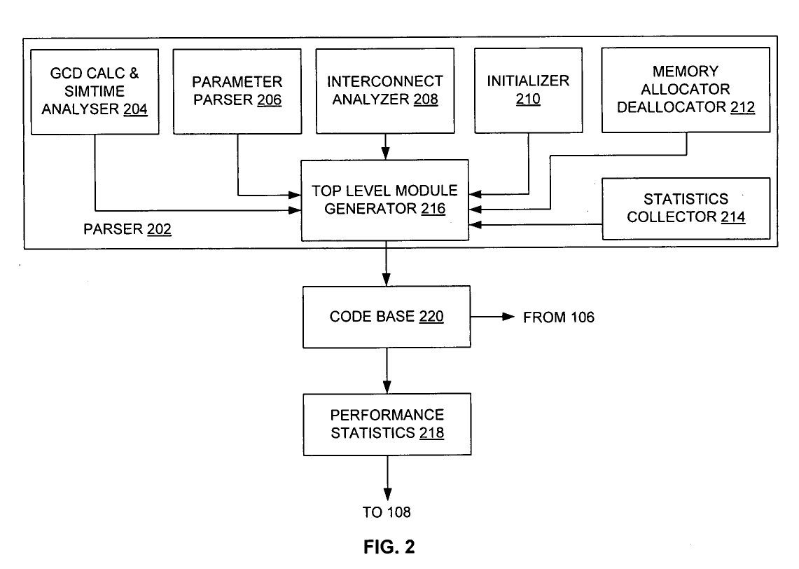

FIG. 2 illustrates an exploded view of the performance analysis block 104 of FIG. 1 according to an embodiment herein. The performance analysis block 104 includes a parser block 202, a code base compilation and simulation block 220, and a performance statistics gathering block 218. The parser block 202 includes a GCD calculation and simulation time analyzer block 204, a parameter parser block 206, an interconnect analyzer block 208, an initializer block 210, a memory allocator/deallocator block 212, a statistics collector 214 and a top level module generator block 216 according to the embodiment herein.

The SoC description and stimulus block 102 sends a SoC description file (e.g., a text file or a graphical format) to the parser block 202. The GCD calculation and simulation time analyzer block 204 calculates the GCD of all the clock speed parameters and uses this GCD as the base of the time unit increments. The SoC description file also contains the simulation time. Using the simulation time and the GCD, the GCD calculation block determines the number of iterations of software modules. During these iterations, each component is executed at the rate of the ratio of its ClockSpeed parameter and the GCD. The parameter parser block 206 extracts the parameters and their values and passes them to the instances of the components.

The interconnect analyzer block 208 enable various components that are described in the SoC description file to communicate with each other via the interconnect signals among all the components. In one embodiment, the connection is point-to-point or point-to-multipoint. The connection is from a single output to single input, or from a single output to multiple inputs. The interconnect analyzer block 208 performs this analysis and automatically generates accurate interconnects among all components.

The initializer block 210 calls initialization routines of all the components so that all the variables are initialized properly before the simulation is performed. The memory allocator/deallocator block 212 determines whether any variables need to be allocated and de-allocated in the top level module, and allocates and de-allocates them as required. The statistics collector block 214 collects the statistical information of each component and sends it to the top level module generator block 216.

The top level module generator block 216 generates a top level module based on all the information generated in the above blocks. The top level module includes instances of various SoC components, indicates whether their parameters are set correctly, indicates whether their initialization routines are getting called, and all the components getting called at correct timings as determined by the GCD calculator block 204, and proper memory allocation and de-allocation. After the top level module has been automatically generated, the parser block 202 automatically compiles the top level module, and all the other SoC components instantiated in the top level module. In one embodiment, the parser block 202 uses the HW Library component database 106 to process the above for compilation and simulation of code in the code base compilation and simulation block 220. In a preferred embodiment, a generated executable file is run (e.g., which is process of simulation) after compilation.

The performance analysis block 104 gathers all the performance statistics from each of the library components of the SoC. The performance statistics of all the blocks is gathered and written in a performance result file (e.g., the performance result block 108 of FIG. 1. In a preferred embodiment, the statistics of hardware library component written into the performance result file are as follows:

Piso (Parallel In Serial Out)

Bytes Transmitted by piso=1401543

PISO Throughput=393 Mbps

FIFO Depth Utilization

Tx Data FIFO Max Fill Level=63

Tx Data FIFO Num Items=3

Rx Data FIFO Max Fill Level=918

Rx Data FIFO Num Items=97

SIPO (Serial In Parallel Out)

Num of Packets received by SIPO=3365

Num of bytes received by SIPO=1413906

SIPO Throughput=396.886 Mbps

DMA Controller

No of Packets Transmitted by DMA=3335

No of Packets Received by DMA=3335

No of Bytes transmitted by DMA Controller 1401565

No of Bytes received by DMA Controller=1402009

Bus Utilization by Bus Master

Bus master Bandwidth Utilization=12.5432%

Max latency=53

Avg latency=18

No of MasACK=178765

No of MasDataAvl=178717

Memory Bandwidth Utilization

No. of bytes written by Mem Controller=1606973

No. of bytes read by Mem Controller=1606725

Memory Bandwidth achieved=902.091 Mbps

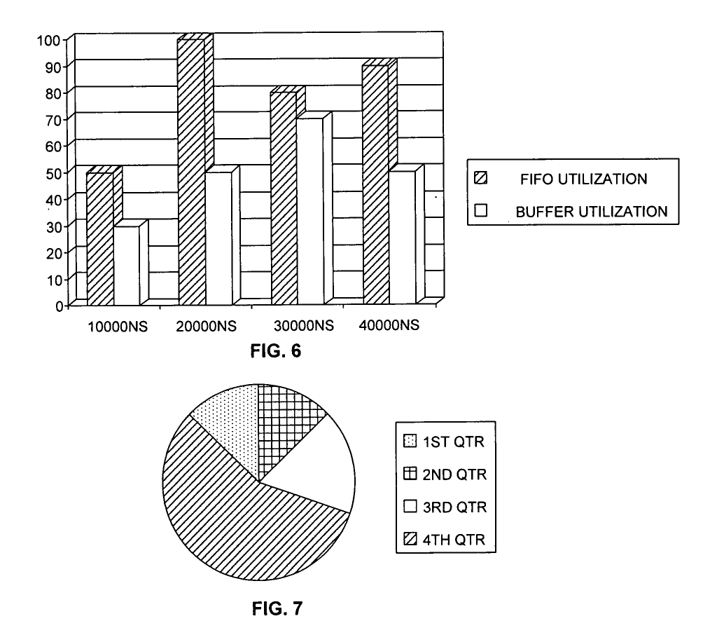

Apart from the result text file generated as mentioned above, the performance result 108 is also displayed graphically in the form of a resource utilization histogram as shown in FIG. 6, a shared resource utilization as shown in FIG. 7, and a time chart of important events during simulation as shown in FIG. 8.

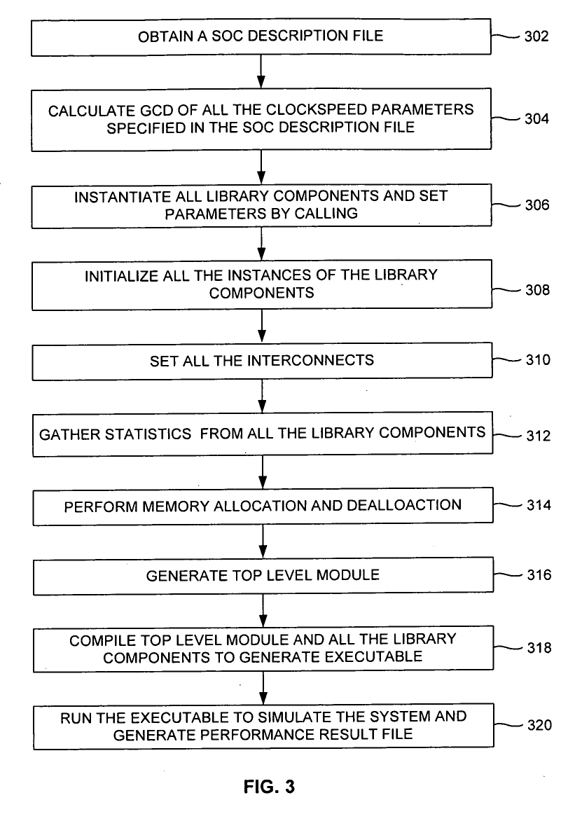

FIG. 3 is a flow diagram illustrating a method of determining a performance result of the SoC of FIG. 1 according to an embodiment herein. In step 302, a SoC description file is obtained. In step 304, a calculation is generated that initiates all the components specified in the description file. In step 306, the components are instantiated and the parameters are set. In step 308, all the instances are initialized by calling initialization routines of all the components so that all the variables are initialized before the simulation is performed.

In step 310, interconnects are set. In one embodiment, all the components are interconnected. In step 312, performance statistics of all the hardware library components is gathered. In step 314, memory allocation and de-allocation is performed. In one embodiment, the variables are allocated and de-allocated. In step 316, a top level module is generated based on all the information generated in the above blocks. In step 318, the top level module and all other components are compiled to generate an executable file. In step 320, the executable file is run to simulate the system and generate performance result file. In step 322, a performed result is obtained based on the simulation. Along with the performance result, the tool also gives suggestions about the architecture changes in order to meet the required performance.

The tool takes an input from the user about what the performance of a certain interface/component should be. The tool after the analysis gets information of what the achieved performance is, and also knows the information about the configurable parameters of the particular component. Using all of these pieces of information, the tool can make educated estimates about what the parameter changes should be. For example, consider the CommPort component of FIG. 5. At one end of this component there is a serial interface and other end has a bus master interface. Suppose a user wishes CommPort to operate at 1 Gbps rate and has 32-bit bus interface operating at 100 MHz, giving a raw bus bandwidth of 3.2 Gbps. Suppose after the analysis, the tool finds that CommPort meets only a 500 Mbps line rate; i.e., only half the required performance is met. Thus, the tool can suggest the bus bandwidth be doubled.

FIGS. 4A-4B are table views of the hardware library component database 106 of FIG. 1 according to an embodiment herein. The hardware library component database 106 includes a component field 402, a parameter field 404, input field 406, and output field 408 according to an embodiment herein. The component field 402 includes a SIPO 410 (Serial In Parallel Out), a memory controller 412, a packet generator 414, arbiter 416, bus master 418, and buffer manager 420 as an illustration.

The SIPO component 410 receives LinkSpeed, ClockSpeed for serial data and datawidth for parallel data as parameters. Based on these parameters it generates parallel data packets and corresponding outputs. The multiport component generates per port IOs. The memory controller 412 receives parameters that set the memory profile (e.g., such as CASLatency, PHYLatency, RefreshRate, etc.). The packet generator 414 receives the parameters as an input that sets up the traffic profile (e.g., such as PktLenRandEn, PktLenUpperThreshold, PktLenLowerThreshold, MaxPkts, InterPktGap, IntraPktGap, NumPorts, etc.). Based on this information, control signals are generated.

The arbiter 416 receives the parameters such as Mode, NumPorts, WeightTimeout, Weights, etc. These parameters are used to make an arbitration between a given number of ports in a specified mode of operation. The bus master 418 is a general purpose master interface that can be used for any bus configuration. The buffer manager 420 gets parameters such as ProgBufferLength, NumBuf, and NumPorts as inputs to allocate, link, or de-allocate buffers and generates corresponding control signals.

The parameter field 404 contains parameters NumSBSignals, LinkSpeed, ClockSpeed, ParDataWidth, TGLatency, TGNumReq, Verbosity, and Mode for the SIPO component 410. The input/output signals corresponding to the SIPO component 410 are SBSignals, PktStatus, DataAvl, PktDone, and PktLen. Further the parameters CASLatency, BurstLength, MemDataWidth, PHYLatency, RefreshRate, ActiveToRW, RWToPrecharge, PrechargeToActive, PrechargeToRefresh, RefreshToActive, MaxRdsPending, MemClockSpeed, Mode, MaxCmdSize, and Verbosity for the memory controller component 412. The corresponding input/output signals are PortReq, PortCmd, PortAck, PortDataAvl, and PortDataDone.

The packet generator component 414 includes parameters such as MaxPkts, NumSBSignals, NumPorts, BurstSize, InterPktGap, IntraPktGap, InterBurstGap, ClockSpeed, LinkSpeed, ParDataWidth, RandEn, En, UpperThreshold LowerThreshold, PktLenUpperThreshold, PktLenLowerThreshold, PktLenRandEn. The corresponding input/output signals are PktStatus, SBSignals, Irdy, and Trdy.

The aribiter component 416 includes parameters such as Mode, NumPorts, Weights, WeightTimeout, Timeout, and Verbosity. The corresponding input/output signals are Req, Gnt, and Ack. The bus master component 418 includes parameters such as MaxCmdSize, Mode, and Verbosity. The corresponding input/output signals are MasCmd, MasReq, MasDataAvl, MasDataDone, MasAck, MasDone, MasRdy, Trdy, BusReq, BusCmd, BusDataAvl, and BusDataDone. The buffer manager component 420 includes NumBuf, ProgBufferLength, NumPorts, BufferLength, and Verbosity. The corresponding input/output signals are Opcode, CurrBuff, NextBuff, BuffDone, Link, and BufferLength.

An example of a DMA controller model 500 is shown in FIG. 11. As described earlier, a SoC description is provided in the form of an input file with a predefined syntax. An exemplary, syntax could be as follows:

Instance Name: Library Component Name
{
Parameter (

| | Parameter 1(Parameter value), |
|---|---|
| | Parameter 2(parameter value), |
| ... | Parameter N (parameter value) |

);

Output (

| | Input/output Event 1, |
|---|---|
| | Input/output Event 2, |
| ... | input/output Event N |
| ); | |

Input (

| | Stimulus1, |
|---|---|
| | Stimulus2, |
| ... | StimulusN |
| ); | |

}

The DMA controller model 500 is one of the most common blocks present in a SoC. An exemplary block diagram of the DMA controller model 500 is shown in FIG. 11, which also shows the man control events which facilitate data transfer across various blocks. SoCs typically have an embedded or an external processor. The processor prepares a buffer descriptor chain, which, in turn provides information to the DMA controller 500 about buffer address, buffer length, and next buffer descriptor pointer. It then enables the DMA controller 500 by writing a pointer to the first buffer descriptor. The DMA controller 500 performs buffer descriptor fetch and then reads packet data from the actual buffer address obtained from the buffer descriptor. These activities take place through the on-chip interconnect bus, for which the DMA controller 500 interacts with the bus interface model 502. The DMA controller 500 stores the read data in a Tx FIFO and then informs the transmitter block 503 about the availability of the packet. The transmitter block 503 then transmits the packet over the physical medium like an Ethernet.

In this system 500, the performance evaluation goal is to evaluate whether the bus interface 502, DMA controller 501, and the transmitter 503 systems connected together as shown in the FIG. 11 meets the wire speed of the transmission medium, for example 10/100 Mbps Ethernet. The following is an example how the system 500 models this functionality and evaluates performance of a SoC.

In this example, the Hardware Library Database 106 of FIG. 1, comprises the bus interface model 502, DMA controller 501, and the transmitter model 503. Various configuration parameters of the DMA controller 501 include the buffer descriptors in the buffer descriptor chain, size of the DMA controller bus, number of bytes transferred in one DMA operation, Tx FIFO depth in bytes, etc. Latency of a read operation is the configuration parameter of the bus interface model 502. The link speed is the configuration parameter of the transmitter model 503. As a part of the tool development, these models are developed such that a user can choose values of these configurable parameters.

The bdwrite signal shown in FIG. 11 indicates a pointer to the first BD being written into the DMA controller 501. Thus, it generates the primary stimulus to the DMA controller 501. Subsequent BD fetch and buffer fetch operations of the DMA controller 501 are represented by the xfer_pending event which is driven from DMA controller 501 to the bus interface module 502, as shown in FIG. 11. The data_avl event from the bus interface 502 indicates the data is available for the DMA controller 501. The DMA controller 501 then models the data reception and data being stored into the Tx FIFO. When an entire packet is stored into the Tx FIFO, the DMA controller 501 generates a Tx_pkt_available event to the transmitter model 503. The transmitter model 503 then models the behavior of data being transmitted over a physical medium, for example, an Ethernet.

Based on the above description, an exemplary input file for this specific example could be as follows:

```
myStimulus: Stimulus
{
Parameter (
        CLOCKSPEED(8)
    )
Output (
    Bdwrite(mybdwrite)
    )
}
myDMAController: DMAController
{
Parameter (
    No_of_BDs (32),
    DMA_BUS_SIZE (32),
    DMA_SIZE (64),
    TXFIFO_DEPTH (128),
    CLOCKPERIOD(8)
    );
Output (
    Xfer_pending(myxfer_pending),
    packet_available(my_packet_available)
    );
Input (
    Bdwrite(mybdwrite),
    data_available(my_data_available)
    );
}
myBusInterface: BusInterface
{
Parameter (
    Latency (20),
    CLOCKPERIOD(8)
    );
Output (
    data_available(my_data_available)
    );
Input (
    Xfer_pending(my_xfer_pending)
}
myTransmitter : Transmitter
{
Parameter (
    link_speed (10),
    CLOCKPERIOD(8)
    );
Input (
    packet_available(my_packet_available)
    );
}
```

A front end software compiler is present in the system, and after parsing this input file, performs the following operations:

finding out 8 ns as the unit of time increment;

generating random bdwrite stimulus;

generating instances of the library components;

passing configured parameter values to the instances;

passing interconnect events from one instance to other, like xfer_pending event being passed from DMA controller instance 501 to the bus interface instance 502. Likewise, data_avl event is passed from the bus interface instance 502 to the DMA controller instance 501;

gathering performance statistics from various instances and displaying it at the end of the performance analysis.

An example of usage of the tool is illustrated in the FIG. 5 where a system to store and forward packets such as a repeater is modeled. Data flow of packets in the system is as follows:

Packets of random length are generated by the packet generator, which is the stimulus to the SoC. The packet is received by the CommPort module. The CommPort interfaces to the buffer manager to get buffers for packet storage. Then, a DMA operation is performed to store the packet into the packet memory. Then, an interrupt is provided to the CPU and then CPU forwards the packet to the transmit side. A transmit module in the CommPort performs another DMA operation to read the packet from the packet memory and the packet is modeled to be serially transmitted out.

In this system, a SoC architect will bring the appropriate library components, like the packet generator, CommPort, buffer manager, MPMC, and CPU into the drawing canvas of the GUI and draw interconnections among predefined interfaces among the components. The SoC architect also sets parameters of various components and clicks the run button of the GUI. Upon clicking the run button, all the performance analysis activities mentioned in FIG. 2 are executed in the order specified by the flowchart in FIG. 3 and the performance results 108 are displayed in terms of the time chart (FIG. 6), pie chart (FIG. 7), and histogram (FIG. 8) as previously described.

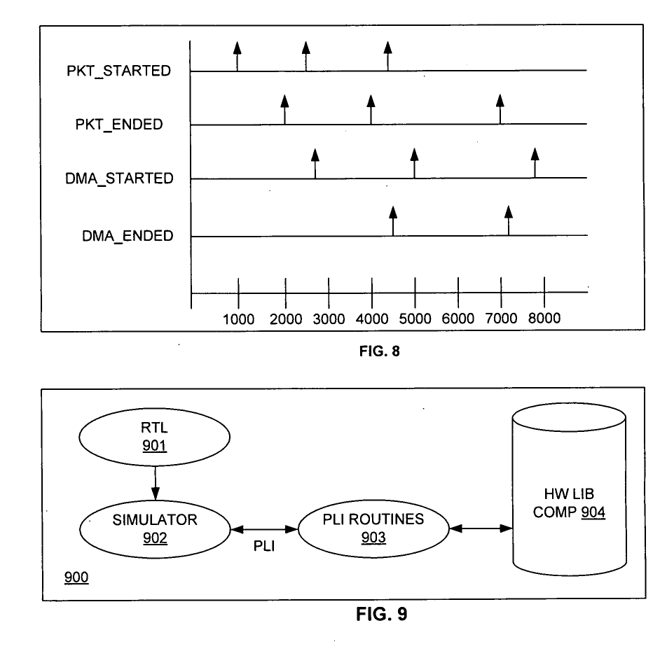

FIG. 9 illustrates a block diagram of the tool 900 for performance evaluation at the RTL stage. This tool 900 uses RTL 901 and the RTL simulation 902 techniques which are extremely common in chip development. This tool 900 also uses library components 904 but mainly for performance statistics gathering. Even for performance statistics gathering, library components 904 do need appropriate parameter settings and interconnect signals to be driven. In this tool 900, these signals are driven from the RTL 901 and passed to the library components 904 via a simulator 902 and PLI (Programmable Language Interface) routines 903.

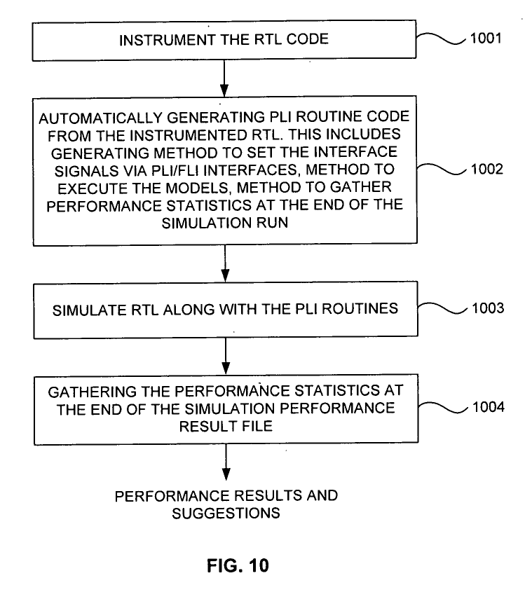

FIG. 10, with reference to FIG. 9, illustrates a flowchart of the performance evaluation tool 900 at the RTL stage. The first step 1001 is to instrument the code to identify which RTL signals need to be driven to the library components 904 and vice versa. Once the RTL 901 is instrumented, the next step 1002 is to automatically generate the PLI routine code from the instrumented RTL 901. This includes generating routines for setting parameters of the library components 904, routines 903 to drive the interconnect signals from the RTL 901 to the library components 904 and vice versa, routines 903 to execute library components 904, and routines 903 to gather performance statistics at the end of the simulation run 902. Once all these routines are automatically generated, next step 1003 is to simulate 902 the RTL along with the PLI routines 903. After simulation 902, the performance results and performance improvement suggestions are gathered 1004 and displayed graphically and in the text file in the same manner as is performed by the architecture stage tool.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

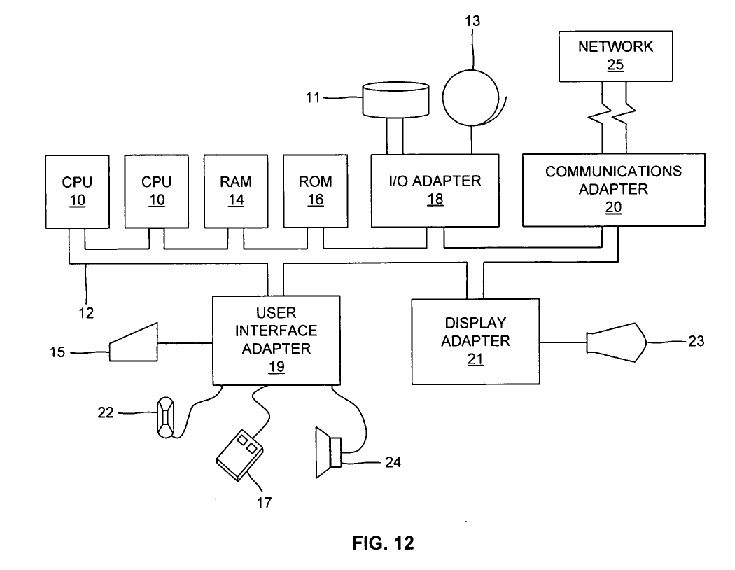

A representative hardware environment for practicing the embodiments herein is depicted in FIG. 12. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of performing transaction level System on Chip (SoC) performance analysis, said method comprising:
obtaining a SoC description file comprising all intellectual property (IP) modules interconnected in a SoC via interconnects;
calculating clock periods of said IP modules;
calculating a greatest common divisor (GCD) of all said clock periods;
receiving user-specified inputs that stimulate said SoC and generate a signal at an output of said SoC;
gathering timing and interconnect statistics from said SoC;
automatically generating a top level module based on said statistics;
compiling said top level module and said components to generate an executable file;
simulating a SoC system by running said executable file; and
generating performance results from the simulated SoC system.

2. The method of claim 1, further comprising gathering said statistics from a hardware library database.

3. The method of claim 2, wherein said hardware library database comprises a direct memory access (DMA) controller module, a bus interface module, and a transmitter module, and wherein the modules comprise user-configurable parameters, and wherein said performance results comprise an evaluation of whether said DMA controller module, said bus interface module, and said transmitter module connected together meet a required wire speed of a predetermined corresponding transmission medium.

4. The method of claim 1, further comprising identifying a reference time period as a base timing unit for performing the simulation of said SoC system.

5. The method of claim 4, wherein said GCD corresponds to said reference time period.

6. The method of claim 1, wherein said SoC description file comprises any of a text format and a graphical format that is convertible into said text format.

7. The method of claim 1, wherein said IP modules comprise user-configurable parameters and key interconnects that facilitate data transfer from one IP module to another IP module in said SoC.

8. The method of claim 1, wherein said performance results comprise bus bandwidth utilization, data rates achieved at various media interfaces in said SoC, FIFO depth utilization, and a request to grant latency of an arbiter associated with said SoC.

9. The method of claim 1, wherein said performance results are generated without register-transfer level (RTL) computer code.

10. The method of claim 2, further comprising:
identifying register-transfer level (RTL) signals to interact with said hardware library database;
automatically generating programmable language interface (PLI) routine code from said RTL signals; and
simulating said RTL signals and said PLI routine code,
wherein said performance results comprise the simulated RTL signals and PLI routine code.

11. A program storage device readable by computer and comprising a program of instructions executable by said computer to perform a method of performing transaction level System on Chip (SoC) performance analysis, said method comprising:
obtaining a SoC description file comprising all intellectual property (IP) modules interconnected in a SoC via interconnects;
calculating clock periods of said IP modules;
calculating a greatest common divisor (GCD) of all said clock periods;
receiving user-specified inputs that stimulate said SoC and generate a signal at an output of said SoC;
gathering timing and interconnect statistics from said SoC;
automatically generating a top level module based on said statistics;
compiling said top level module and said components to generate an executable file;
simulating a SoC system by running said executable file; and
generating performance results from the simulated SoC system.

12. The program storage device of claim 11, wherein said method further comprises gathering said statistics from a hardware library database.

13. The program storage device of claim 12, wherein said hardware library database comprises a direct memory access (DMA) controller module, a bus interface module, and a transmitter module, and wherein the modules comprise user-configurable parameters, and wherein said performance results comprise an evaluation of whether said DMA controller module, said bus interface module, and said transmitter module connected together meet a required wire speed of a predetermined corresponding transmission medium.

14. The program storage device of claim 11, wherein said method further comprises identifying a reference time period as a base timing unit for performing the simulation of said SoC system.

15. The program storage device of claim 14, wherein said GCD corresponds to said reference time period.

16. The program storage device of claim 11, wherein said SoC description file comprises any of a text format and a graphical format that is convertible into said text format.

17. The program storage device of claim 11, wherein said IP modules comprise user-configurable parameters and key interconnects that facilitate data transfer from one IP module to another IP module in said SoC.

18. The program storage device of claim 11, wherein said performance results comprise bus bandwidth utilization, data rates achieved at various media interfaces in said SoC, FIFO depth utilization, and a request to grant latency of an arbiter associated with said SoC.

19. The program storage device of claim 11, wherein said performance results are generated without register-transfer level (RTL) computer code.

20. The program storage device of claim 12, wherein said method further comprises:
identifying register-transfer level (RTL) signals to interact with said hardware library database;
automatically generating programmable language interface (PLI) routine code from said RTL signals; and
simulating said RTL signals and said PLI routine code,
wherein said performance results comprise the simulated RTL signals and PLI routine code.

21. A system for performing transaction level System on Chip (SoC) performance analysis, said system comprising:
a SoC description file comprising all intellectual property (IP) modules interconnected in a SoC via interconnects;
a processor that calculates clock periods of said IP modules, and calculates a greatest common divisor (GCD) of all said clock periods;
a graphical user interface (GUI) that receives user-specified inputs that stimulate said SoC and generate a signal at an output of said SoC;
a hardware library database comprising timing and interconnect statistics from said SoC;
a tool that automatically generates a top level module based on said statistics;
a compiler that compiles said top level module and said components to generate an executable file; and
a simulator that simulates a SoC system by running said executable file, and generates performance results from the simulated SoC system.
